(19) United States
(12) Patent Application Publication
(10) Pub. No.: US 2005/0060748 A1
(43) Pub. Date: Mar. 17, 2005

(54) Programming service offer presentment and instant actvation system, method, and computer program product

(75) Inventors: Jordan S. Berman, New York, NY (US); Justin C. Edelson, Crompond, NY (US); Ann E. McGowan, New York, NY (US); Kevin M. Parks, Colts Neck, NJ (US); James G. Occhiuto, Smithtown, NY (US); David Preisman, New York, NY (US)

Correspondence Address: VENABLE, BAETJER, HOWARD AND CIVILETTI, LLP, P.O. BOX 34385, WASHINGTON, DC, 20043-9998, US

(73) Assignee: Showtime Networks Inc., New York, NY (US)

(21) Appl. No.: 10/803,116

(22) Filed: Mar. 18, 2004

Related U.S. Application Data
(60) Provisional application No. 60/502,952, filed on Sep. 16, 2003.

(51) Int. Cl. H04N 5/445; G06F 3/00; H04N 7/16; G06F 13/00; G06F 17/60

(52) U.S. Cl. 725/61; 725/60; 725/1; 705/26

(57) ABSTRACT

An exemplary embodiment of the present invention is directed to a system, method, and computer program product for electronically upgrading a user content subscription for programming services. In an exemplary embodiment, the method can include the steps of: (a) identifying at least one content distributor available to a user; (b) identifying a price to the user for a programming service from the at least one content distributor; (c) presenting an offer for the programming service to the user for the price; (d) receiving an acceptance of the offer for the programming service for the price; and (e) activating the programming service.

### CROSS REFERENCE TO RELATED PATENT APPLICATIONS

This U.S. Non-Provisional Patent Application claims priority to and is related to U.S. Provisional Patent Application Ser. No. 60/502,952, Attorney Docket Number 39601-193185, entitled, “Instant Activation with Rebate Content Distribution System, Method, and Computer Program Product,” to BERMAN et al., filed on Sep. 16, 2003, of common assignee to the present invention, the contents of which are incorporated herein by reference in their entirety.

### BACKGROUND OF THE INVENTION

1. Field of the Invention

The present invention relates to the field of content distribution. More particularly, this invention relates to an improved method of provisioning a content distribution system.

2. Related Art

Content such as television programming can include, e.g., a programming service. An example of a programming service is a subscription programming service, such as, e.g., SHOWTIME, available from SHOWTIME NETWORKS INC. of New York, N.Y., USA. Content providers offer programming services as a product. An example of a content provider is, e.g., SHOWTIME NETWORKS INC. Content distributors own networks that can be used to distribute content. Examples of content distributors include, e.g., COMCAST CORPORATION of Philadelphia, Pa., USA, DIRECTV of El Segundo, Calif., U.S.A., and TIME WARNER CABLE of Stamford, Conn., U.S.A. Conventionally, content is distributed over various network platform types including, e.g., voice, data, cable television (CATV), wireless communications networks, satellite television (TV), multichannel multipoint distribution service (MMDS) and wireless fidelity (WI-FI).

In order for, a customer subscriber (referred to herein as a “user”) to receive a subscription programming service, is required to subscribe to the service. Conventionally, the user is required to call the content distributor to subscribe to the programming service. The telephone call is made to a so-called inbound call center, where the user may be placed on hold in a queue, awaiting a response from a customer service agent. Upon subscribing, then the content distributor must provision the network to deliver the programming service to the user. The provisioning process can include, e.g., setting up distribution network components, scheduling in some cases an onsite appointment at the user location, as well as configuring billing systems to allow billing the user. Unfortunately, the conventional process can take a significant amount of time and does not appeal to consumers who desire “instant gratification.”

Popular culture emphasizes instant gratification. For example, overnight package delivery, automated teller machines (ATMs), fast food, instant photos, and in home food delivery demonstrate that modern society increasingly demands expedited delivery of offerings. Impulse buying depends upon immediate delivery.

Customers of content providers and content distributors have been trained to expect instant access by offerings such as, e.g., pay per view (PPV), PPV by remote control, video on demand (VOD), and subscription VOD. PPV is a conventional approach to provide content to a user on a timely basis. However, PPV provides in fixed time schedules, a limited number of offerings, dependent on the number of available channels provided by the content distributor's distribution network platform type. Another conventional solution is VOD, referring to any of various offerings that promise to provide users a selectable list of content offerings from a menu of available offerings.

With the advent of the Internet, users can go online to perform various conventional “offline” tasks, such as, e.g., personal banking, trading of stock, purchase of books and other goods. Several businesses such as, e.g., NETFLIX of Los Gatos, Calif., USA, provide a method of distributing content by online selection and conventional postal delivery distribution of digital versatile disk (DVD) content. A substantial proportion of event and travel ticket sales are now sold online via such sites as, e.g., EXPEDIA available from MICROSOFT CORPORATION of Redmond, Wash., USA, and TRAVELOCITY available from SABRE HOLDINGS of Southlake, Tex., USA. Unfortunately, there is no conventional method of subscribing to a programming service online.

Customer demand has driven growth in size of call centers to provide improvements to customer service for businesses. As companies continue to diversify, supporting larger numbers of products, customer response center call volumes have experienced increases. Content distributors have similarly experienced increased call volumes. Leaving a customer on hold can create a customer perception of a decline in customer service. While the costs of customer care are increasing, competition is also increasing.

What is needed then is an improved technique of activating enhanced content over content distribution systems that overcomes shortcomings of conventional solutions.

### SUMMARY OF THE INVENTION

An exemplary embodiment of the present invention is directed to a system, method, and computer program product for electronically ordering and activating a user content subscription is set forth. In an exemplary embodiment, the method can include, e.g., any of the steps of, e.g.,: (a) identifying one or more content distributors available to a user; (b) identifying a price to the user for a programming service from the one or more content distributors; (c) presenting an offer for the programming service to the user for the price; (d) receiving an acceptance of the offer for the programming service for the price; and/or (e) activating the programming service.

In an exemplary embodiment, step (e) of the method can include (1) determining whether activation fails; and (2) forwarding the acceptance of the offer for the programming service to the one or more content distributors, if the activation fails. In another exemplary embodiment, the activation can, e.g., fail when communication fails with one or more content distributors; communication with a device of the user fails; and/or activation is denied.

In an exemplary embodiment, the offer can include: a programming service price; and a promotional offer. In an exemplary embodiment, the programming service price can include: a user-tailored programming service price; a multi-tiered user service level price; a general price; a content distributor-specific price; a user demographically-tailored programming service price; a user psychographically-tailored programming service price; and/or a discounted price.

In an exemplary embodiment, the promotional offer can include, e.g., any of a user-tailored offer; a rebate; a discount; a free install; a free term of service; a gift certificate; a redemption certificate; a coupon; a content distributor—specific offer; a user demographically-tailored offer; a user psychographically-tailored offer; and/or a special offer associated with the one or more content distributors.

In an exemplary embodiment, step (a) can include, e.g.,: (1) receiving an indication of a location of the user; and/or (2) querying a database that maps the one or more content distributors to the indication of the location of the user.

In an exemplary embodiment, the one or more content distributors can include, e.g.,: a cable television (CATV) content distributor; a satellite content distributor; a wired content distributor; a wireless content distributor; an Internet content distributor; and/or a multi-channel video program distributor (MVPD).

In an exemplary embodiment, indication of the location of the user can include, e.g.,: a zip code; a phone number; an address; an internet protocol (IP) address; a geographical indication; a global positioning system identified location; and/or a reverse 411 identified location.

In an exemplary embodiment, the content distributor can include, e.g., a content distributor presently delivering content to the user.

In an exemplary embodiment, the offer can include, e.g., any of: a programming service price; a promotional offer; a rebate; a free install; a free term of service; a gift certificate; a coupon; a local rebate; a national rebate; a promotional offer; a rebate; a free install; a free term of service; a gift certificate; a local offer; a national offer; a targeted offer; an offer targeted to the user using demographic and psychographic information about the user; a discount; a content distributor-specific offer; a user-tailored programming service price; a tiered user service level price; a user demographically-tailored offer; a user demographically-tailored programming service price; a user psychographically-tailored offer; a user psychographically-tailored programming service price; an offer associated with the one ore more content distributors presently delivering content to the user; a programming service price associated with the one or more content distributors presently delivering content to the user; a redemption certificate; and/or a coupon. A national rebate may be offered to all regardless of location and/or content distributor, a local rebate may be a non-national rebate, such as, e.g., a rebate offered only by an MSO. National and local offers are similar to national and local rebates.

In an exemplary embodiment, the step (e) can include: (1) activating a billing system; and/or (2) activating an access control system to distribute the programming service to the user.

In an exemplary embodiment, the method can include: placing a programming service in a channel guide of the user; activating a programming service; providing access to the programming service; and/or enabling premises equipment to decode the programming service.

In an exemplary embodiment, the access control system can include, e.g.,: a digital access controller (DAC); and/or a digital network access control system (DNCS).

In an exemplary embodiment, the step (d) can include: (1) receiving the acceptance via: a set-top box, a television (TV), a browser, a digital video recorder (DVR), a computer, a personal digital assistant (PDA), a wireless device, a communications device, a phone, or an Internet browser. It is important to note that whenever a DVR is mentioned herein, the term should be interpreted to also encompass personal video recorders (PVRs) such as, e.g., those available from TIVO INC. of San Jose, Calif. USA.

In an exemplary embodiment, the step (a) can include: (1) identifying one or more content distributors having capability to deliver content to a user.

In an exemplary embodiment, the programming service price may be user-tailored by: maintaining multiple accounts for at least one user; and/or maintaining multiple users for at least one account.

In an exemplary embodiment, the method can further include, prior to (a), a step (f) transmitting an electronic postcard from a sending user to a receiving user where the postcard an include information about programming service content, and/or where the postcard can include a link to the method for electronically ordering and activating the user content subscription.

In yet another exemplary embodiment of the present invention, a system for electronically upgrading a user content subscription can include, e.g.,: content distributor identification means for identifying one or more content distributors available to a user; pricing means for identifying a price to the user for a programming service from the one or more content distributor; presentment means for presenting an offer for the programming service to the user for the price; acceptance means for receiving an acceptance of the offer for the programming service for the price; and/or activation means for activating the programming service.

In an exemplary embodiment, the activation means can include, e.g.,: means for determining whether activation fails; and/or means for forwarding the acceptance of the offer for the programming service to the one or more content distributors, if the activation fails.

In an exemplary embodiment, the activation can fail when, e.g., communication fails with the one or more content distributors; communication with a device of the user fails; and/or activation is denied.

In an exemplary embodiment, the offer can include, e.g.,: a programming service price; and/or a promotional offer.

In an exemplary embodiment, the programming service price can include, e.g.,: a user-tailored programming service price; a multi-tiered user service level price; a general price; a content distributor-specific price; a user demographically-tailored programming service price; a user psychographically-tailored programming service price; and/or a discounted price.

In an exemplary embodiment, the promotional offer can include, e.g.,: a user-tailored offer; a rebate; a free install; a free term of service; a gift certificate; a content distributor-specific offer; a user demographically-tailored offer; a user psychographically-tailored offer; and/or a special offer associated with the one or more content distributors.

In an exemplary embodiment, the content identification means can include, e.g., means for receiving an indication of a location of the user; and/or means for querying a database that maps the one or more content distributors to the indication of the location of the user.

In an exemplary embodiment, the one or more content distributors can include, e.g.,: a cable TV (CATV) content distributor; a satellite content distributor; a wired content distributor; a wireless content distributor; an Internet content distributor; and/or a multi-channel video program distributor (MVPD).

In an exemplary embodiment, the content distributor can include, e.g., a content distributor presently delivering content to the user.

In an exemplary embodiment, the indication of the location of the user can include, e.g.,: a zip code; a phone number; an address; an internet protocol (IP) address; a geographical indication; a global positioning system identified location; and/or a reverse 411 identified location.

In an exemplary embodiment, the offer can include, e.g.,: a programming service price; promotional offer; a rebate; a free install; a free term of service; a gift certificate; a local rebate; a national rebate; a promotional offer; a local offer; a national offer; a targeted offer; an offer targeted to the user using demographic and psychographic information about the user; a discount; a content distributor-specific offer; a user-tailored programming service price; a tiered user service level price; a user demographically-tailored offer; a user demographically-tailored programming service price; a user psychographically-tailored offer; a user psychographically-tailored programming service price; an offer associated with the one or more content distributors presently delivering content to the user; a programming service price associated with the one or more content distributors presently delivering content to the user; a redemption certificate; and/or a coupon.

In an exemplary embodiment, the activation means can include, e.g.,: billing means for activating a billing system; and/or access means for activating an access control system to distribute the programming service to the user.

In an exemplary embodiment, the access means can include, e.g.,: means for placing in a channel guide of the user; means for activating the content; means for providing access to the content; and/or means for enabling premises equipment to decode the content.

In an exemplary embodiment, the access control system can include, e.g.,: a digital access controller (DAC); and/or a digital network access control system (DNCS).

In an exemplary embodiment, the acceptance means can include, e.g.,: means for receiving the acceptance via: a set-top box, a television (TV), a browser, a digital video recorder (DVR), a computer, a personal digital assistant (PDA), a wireless device, a communications device, a phone, and/or an Internet browser.

In an exemplary embodiment, the content distributor identification means can include, e.g., means for identifying one or more content distributors having capability to deliver content to a user.

In an exemplary embodiment, the content distributor identification means can include, e.g., means for identifying one or more content distributor presently providing service to the user.

In an exemplary embodiment, the system can further include, e.g.,: means for transmitting an electronic postcard from a sending user to a receiving user where the postcard can include information about programming service content, and where the postcard can include a link to the system for electronically ordering and activating the user content subscription.

In another exemplary embodiment of the present invention, the acceptance means can include a computer program product embodied on a computer readable medium including program logic for instantaneously activating enhanced content including: content distributor identification means for enabling a computer to identify one or more content distributors available to a user; pricing means for enabling the computer to identify a price to the user for a programming service from the one or more content distributors; presentment means for enabling the computer to present an offer for the programming service to the user for the price; acceptance means for enabling the computer to receive an acceptance of the offer for the programming service for the price; and/or activation means for enabling the computer to activate the programming service.

Further features and advantages of the invention, as well as the structure and operation of various embodiments of the invention, are described in detail below with reference to the accompanying drawings.

### BRIEF DESCRIPTION OF THE DRAWINGS

The foregoing and other features and advantages of the invention will be apparent from the following, more particular description of exemplary embodiments of the invention, as illustrated in the accompanying drawings. In the drawings, like reference numbers generally indicate identical, functionally similar, and/or structurally similar elements. The drawing in which an element first appears is indicated by the leftmost digits in the corresponding reference number. A preferred exemplary embodiment is discussed below in the detailed description of the following drawings:

FIG. 1 depicts an exemplary embodiment of a client server computing environment that could be used to implement an exemplary embodiment of an user environment for a network based instantaneous activation programming service offer presentment system according to the present invention;

FIG. 2 depicts an exemplary embodiment of a high level diagram illustrating an programming service offer presentment and instantaneous activation system according to the present invention;

FIG. 3A depicts an exemplary embodiment of a more detailed diagram illustrating an exemplary offer presentment for programming service subscription system according to the present invention;

FIG. 3B depicts an exemplary embodiment of a more detailed diagram illustrating an exemplary activation of service process for the instantaneous activation of programming service system according to the present invention;

FIG. 4 depicts an exemplary embodiment of a computer and/or communications system as can be used for several components in an exemplary embodiment of the present invention;

FIG. 5A depicts an exemplary embodiment of a flow chart illustrating a method of establishing a pay per view event;

FIG. 5B depicts another exemplary embodiment of a flow chart illustrating a method of establishing an experimental pay per view event;

FIG. 6 depicts an exemplary embodiment of a graphical user interface depicting an exemplary first step of an instantaneous activation programming service offer presentment system prompting for user identification according to the present invention;

FIG. 7 depicts an exemplary embodiment of a graphical user interface depicting an exemplary second step of the instantaneous activation programming service offer presentment system providing a response to input of a user identification information according to the present invention;

FIG. 8 depicts an exemplary embodiment of a graphical user interface depicting an exemplary third step of the instantaneous activation programming service offer presentment system prompting the user to provide additional exemplary registration information and to request an exemplary coupon or redemption certificate according to the present invention;

FIG. 9 depicts an exemplary embodiment of a graphical user interface depicting an exemplary fourth step of the instantaneous activation programming service offer presentment system providing a user printable rebate coupon, or redemption certificate for redeeming an offer according to an exemplary embodiment of the present invention;

FIG. 10 depicts an exemplary embodiment of a graphical user interface depicting an exemplary interactive television (iTV) interface offering instantaneous activation programming service offer presentment system according to the present invention;

FIG. 11 depicts an exemplary embodiment of an experimental online web based pay per view sign up system for providing an instantaneous activation according to an exemplary embodiment;

FIG. 12 depicts an exemplary embodiment of a graphical user interface depicting an exemplary CATV cable service locator database query interface that could be used as a component of the present invention;

FIG. 13 depicts an exemplary embodiment of a graphical user interface depicting an exemplary iTV electronic commerce interface that could be interactively used by a user to order a service upgrade;

FIG. 14 depicts an exemplary embodiment of a graphical user interface depicting an exemplary iTV electronic commerce interface that could be interactively used by a user to order a programming service;

FIG. 15 depicts an exemplary embodiment of a graphical user interface depicting another exemplary iTV electronic commerce interface providing scrollable details that could be interactively used by a user to order a programming service;

FIG. 16 depicts an exemplary embodiment of a graphical user interface (GUI) depicting an exemplary iTV electronic commerce interface promotional advertisement offering a subscription and a gift that could be interactively used by a user to order a programming service;

FIGS. 17A and 17B depict exemplary embodiments of promotional materials that could be used to market an instantaneous activation programming service offer presentment system according to exemplary embodiments;

FIG. 18 depicts an exemplary embodiment of a GUI providing an exemplary content layout for an electronic postcard including an instantaneous activation programming service offer presentment system;

FIG. 19 includes an exemplary embodiment of an electronic postcard including a description of a specific movie and an ordering button for a programming service instantaneous activation programming service offer presentment system according to the present invention;

FIG. 20 includes an exemplary embodiment of an electronic postcard including a description of a programming series including an ordering button for a programming service instantaneous activation programming service offer presentment system labeled order SHO NEXT now according to the present invention;

FIG. 21 includes an exemplary embodiment of an electronic postcard including a description of a movie and an ordering button for a programming service instantaneous activation programming service offer presentment system according to the present invention, labeled Order Showtime Now;

FIG. 22 includes an exemplary embodiment of an electronic postcard including a description of an original series and an ordering button for a programming service instantaneous activation programming service offer presentment system according to the present invention; and

FIG. 23 includes an exemplary embodiment of an electronic postcard including a template of the postcard for an original series and an ordering button for a programming service instantaneous activation programming service offer presentment system according to the present invention.

### DETAILED DESCRIPTION OF AN EXEMPLARY EMBODIMENT OF THE PRESENT INVENTION

A preferred embodiment of the invention is discussed in detail below. While specific implementations are discussed, it should be understood that this is done for illustration purposes only. A person skilled in the relevant art can recognize that other components and configurations may be used without parting from the spirit and scope of the invention.

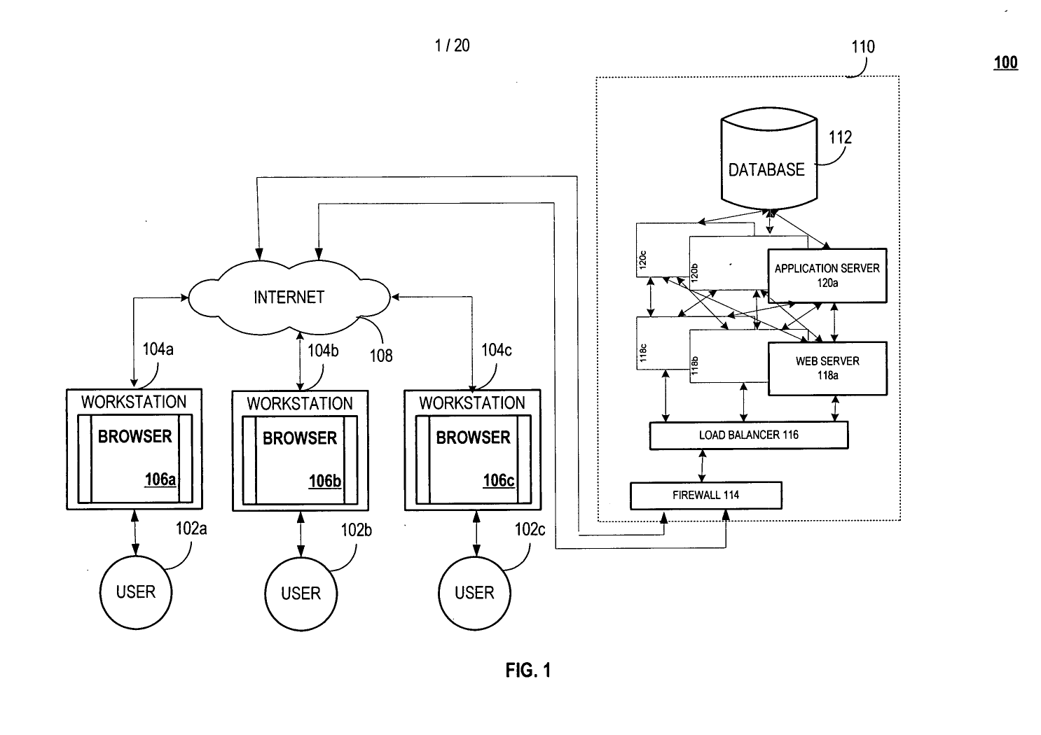

FIG. 1 depicts an exemplary embodiment of a high level system block diagram 100 that can be used to provide an exemplary programming service offer presentment and instant activation system according to the present invention. The high level system block diagram 100 includes, in an exemplary embodiment, users 102a, 102b and 102c interacting with browsers 106a, 106band 106c, respectively. Browsers 106a, 106band 106c can be application software programs executing on computer workstations 104a, 104b and 104c (collectively 104). Workstations 104 can be coupled via a network 108 such as the global Internet to an application server 120, such as, e.g., a database management system (DBMS). Access to the application server 120 can be accomplished by one or more web servers 118a-c (collectively 118) and/or other components shown and not shown in FIG. 1. The application server 120 can manage one or databases 112. Application server 120 can include one or more application servers 120a-c. In an exemplary embodiment, the application server 120 can access a database 112 having a plurality of data records, each data record having one or more fields. It will be apparent to those skilled in the art, that database 112 can be part of a larger database, or could be broken into a plurality of separate subdatabases. In an exemplary embodiment of the present invention, search results can include a plurality of records obtained from database 112 that meet search criteria included in a search query.

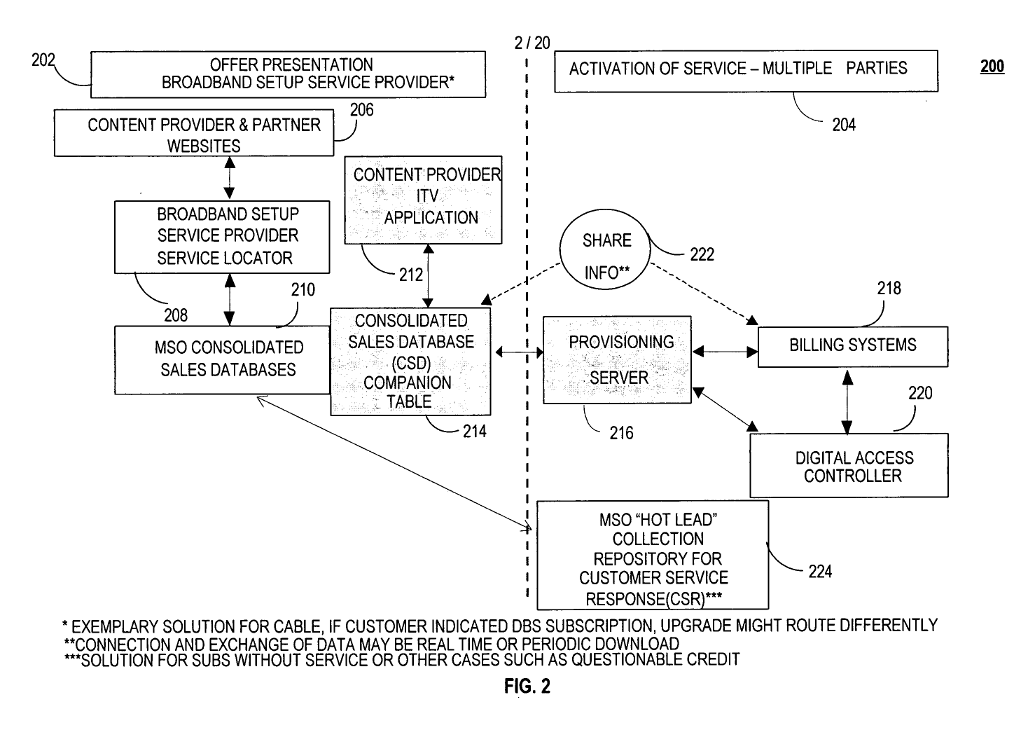

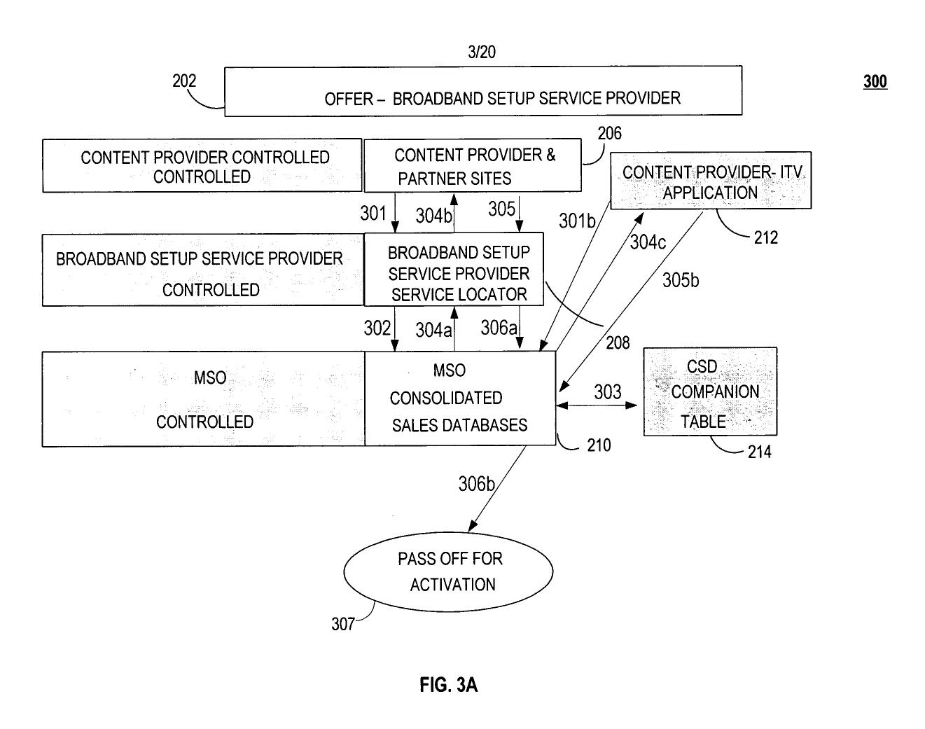

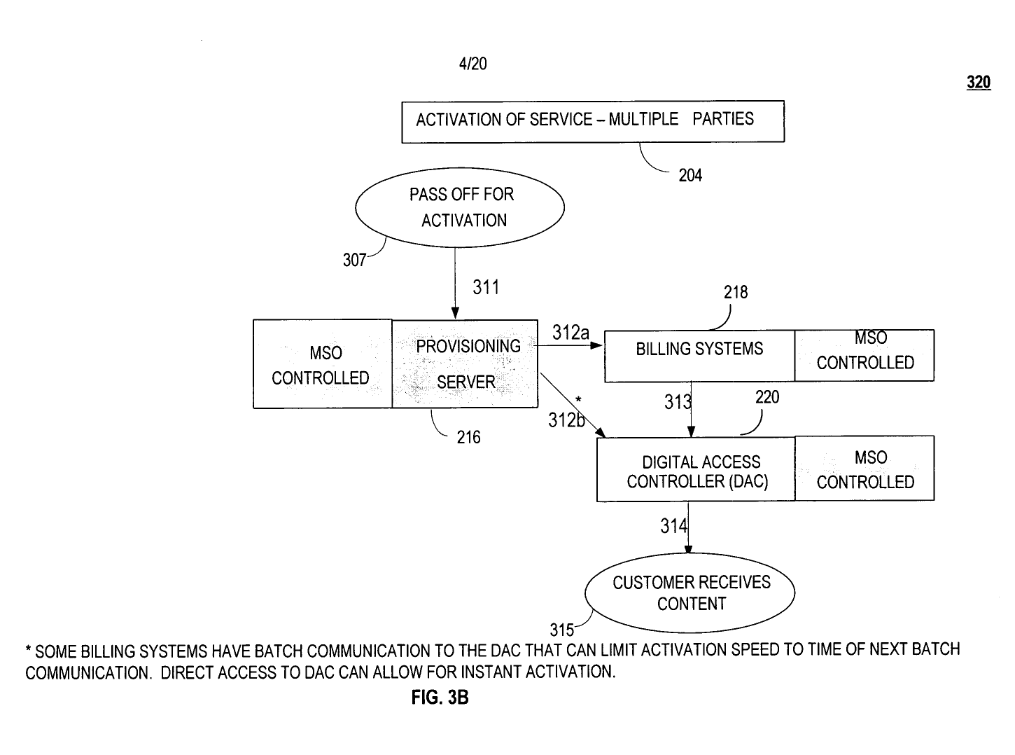

A user 102a interacting with a browser 106a on workstation 104a can access the database 112, in an exemplary embodiment by traversing several intervening networks using well known communications protocols such as, e.g., TCP/IP. Specifically, in an exemplary embodiment, the workstation 104a can be coupled via network 108 including, e.g., the global Internet to website system 110. Website system 110 in an exemplary embodiment can be a website of Showtime (sho.com) available from SHOWTIME NETWORKS INC. of New York, N.Y., USA. The website system 110 can include, in an exemplary embodiment, a firewall 114 coupled to a load balancer 116 (which could alternatively run on a general purpose computer such as, e.g., web server 118a). Load balancer 116 can be coupled to a web server 118a, 118b, and 118c. Web servers 118a-c can be mesh coupled to one or more application servers 120a, 120b, and 120c, each of which can include, or be coupled to, one or more databases 112. Web servers 118a-c, in an exemplary embodiment, can perform load balancing functions by transferring user requests/queries to one or more of the application servers 120a, 120band 120c according to well known semantics. Results of the search queries from database 112 can be transferred from application servers 120a-120c through web servers 118a-c through the network 108 to workstation 104. Separately, other application servers 120 can be accessible over, e.g., network 108. Database 112 can include, e.g., consolidated sales databases (CSD) 210, broadband setup service provider service locator 208, and CSD companion table 214, all described further below with reference to FIGS. 2 and 3A. Other exemplary systems can include, e.g., a billing system 218 and provisioning server 216, both described further below with reference to FIGS. 2 and 3B. Separately, a content distribution system, (not shown in FIG. 1) can be used to distribute content to users 102 from content distributors using such devices as, e.g., digital access controller 220 described further below with reference to FIGS. 2 and 3B.

Conventionally, if users 102a-c desire to subscribe to a programming service, the users 102a-c must contact their content distributor to subscribe to the programming service. The conventional process can require placing a telephone call to a call center of the content distributor, waiting in a queue, requesting a subscription, and perhaps later scheduling setup, to ultimately obtain the service. The conventional process can be lengthy and may require diligence and patience on the part of the users 102a-c to complete the process.

FIG. 2 depicts an exemplary embodiment of a high level diagram 200 illustrating an programming service order presentment and instantaneous activation system according to the present invention overcoming various shortcomings of conventional solutions. Diagram 200 in an exemplary embodiment can include an exemplary two-part process including offer presentation 202 and activation of service 204. An exemplary embodiment of the present invention is overviewed in FIGS. 2, 3A and 3B, illustrating presentment of an offer to subscribe to a programming service to a user 102 via a browser 106, and if accepted, allowing automated activation of the programming service.

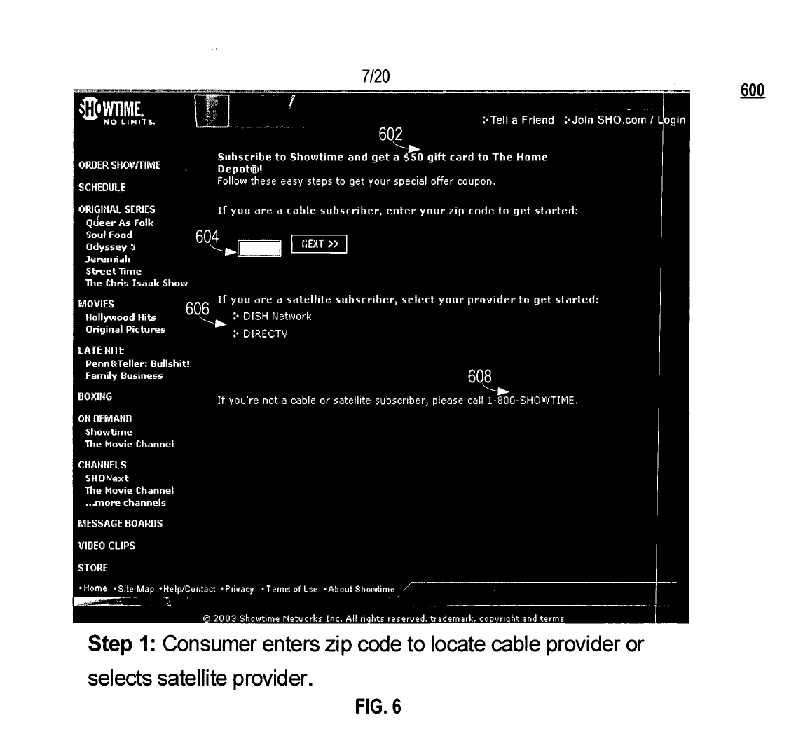

Offer presentation 202 in an exemplary embodiment is described further below with reference to FIG. 3A. In an exemplary embodiment, offer presentation 202 can be provided at a website of a content provider as shown in 206. Suppose users 102a-c visit a website of a content provider or a partner website 206 such as, e.g., a website of Showtime (e.g., sho.com) available from SHOWTIME NETWORKS INC. of New York, N.Y. USA. The users 102a-c can in an exemplary embodiment be presented an offer to subscribe to a programming service. The offer can include an offer to subscribe to the programming service at, e.g., a programming service price tailored to the user 102 along with a promotional offer such as, e.g., a rebate or discount. Exemplary offers are described further below with reference to, e.g., FIGS. 6-11, and 13-17A and 17B. In an exemplary embodiment, users 102a-c after being presented the offer for a programming service, can accept the offer. Exemplary rebates include national and local rebates. A national rebate may be offered to all regardless of location and/or content distributor, a local rebate may be a non-national rebate, such as, e.g., a rebate offered only by an MSO. National and local offers are similar to national and local rebates.

Two exemplary methods of presenting offers for programming service and receiving acceptance are shown in FIG. 2, and are described further below with reference to FIG. 3A. The exemplary methods include presenting offers and receiving an acceptance via a website of a content provider 206 and an interactive television (ITV) application 212. The content provider process can include access to, e.g., application servers 120 such as, e.g., a broadband setup service provider service locator 208, or databases 112 such as, e.g., consolidated sales database (CSD) 210. Similarly, the ITV process can include access to, e.g., application servers 120 such as, e.g., the content provider ITV application 212, or databases 112 such as, e.g., consolidated sales database (CSD) companion table 214. Upon acceptance of the offer, the programming service can be activated.

Activation of service 204 is described further below with reference to FIG. 3B. As illustrated, activation of service 200 can involve multiple parties, e.g., content distributors, third party solution providers, operators and vendors of equipment or services used by content distributors, but an exemplary party is depicted for illustration. The CSD databases 210, 214 can communicate with a provisioning server 216 as shown which in turn can communicate with billing systems 218 and an access control system such as, e.g., digital access controller 220. The billing system 218 can be used to activate billing. The access control system can be used to activate the programming service for the user. Should activation fail, a lead can be stored using, e.g., information from the CSD database 210, and a “hot lead” collection repository 224 for further response. As shown in 222, information from the CSD databases 210, 214 can be shared with billing systems 218. The coupling, or connection and exchange of data between CSD companion table 214 and billing system 218 can be in real time, or alternatively via a download, where the download can be periodic.

It is important to note that the exemplary solution for presenting an offer is described using an exemplary CATV content distributor. Of course alternative content distributors can be used in keeping with the present invention, such as, e.g., a satellite content distributor, an Internet content distributor, a multi-channel video program distributor (MVPD), or other wired or wireless content distributor.

FIG. 3A depicts an exemplary embodiment of a more detailed diagram 300 illustrating an exemplary offer presentment subsystem 202 of the programming service offer presentment system and instantaneous activation system 200 according to the present invention.

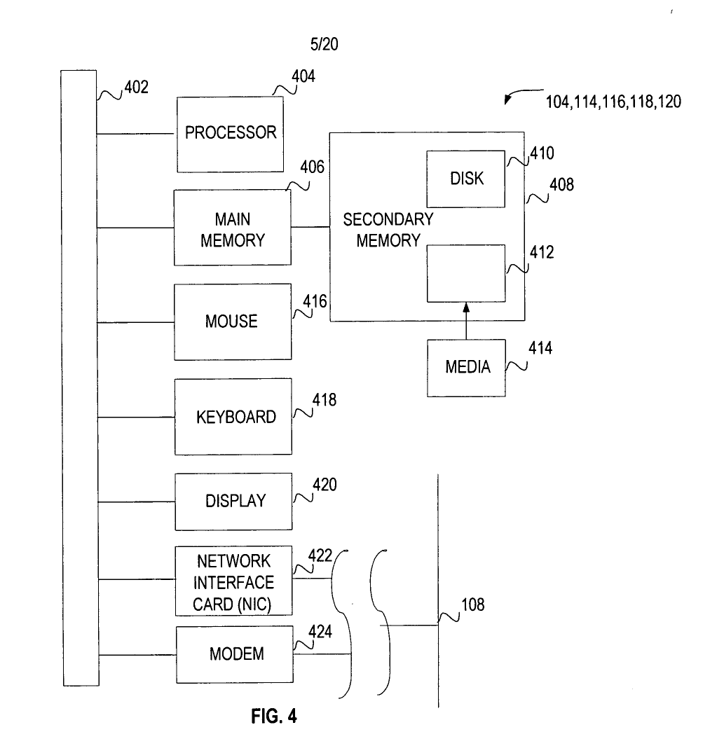

As shown in diagram 300, user 102 can be presented an offer 202 for a subscription to a programming service for acceptance at a content provider's website. The process can begin with the user 102 accessing the content provider website 206 using, e.g., a browser 106, on a workstation 104. The content provider website can execute on and the user can use a device to access the website, by using any computing or communications device, such as, e.g., that described below with reference to FIG. 4. The user 102 can be prompted by the content provider website to provide user information about the location of the user 102, to assist in tailoring an offer for the user.

The user information can be sent as shown in 301 to broadband setup service provider locator 208 to identify content distributors with capability to distribute content to the user 102.

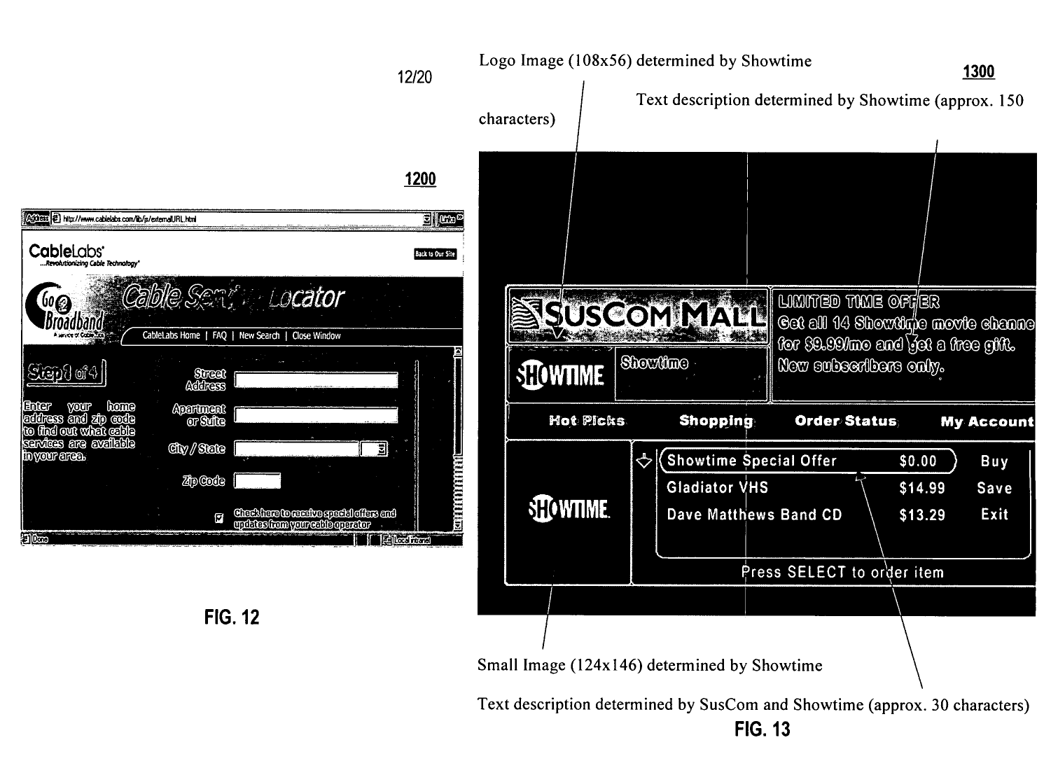

The broadband setup service provider locator 208 can determine a content distributor available to the user 102, or having capability to distribute content to the user 102. In the exemplary CATV content distributor solution, a broadband setup service provider locator 208 can be used, as depicted in FIG. 12. FIG. 12 depicts a web query site that can identify CATV content distributors with the ability to service a geographic location of user 102. The exemplary broadband setup service provider locator 208 can be a Go2Broadband cable service locator available online at cpss.go22broadband.com, and made available from CABLE LABS of Louisville, Colo. USA. In an exemplary embodiment of the present invention, the broadband setup service provider can identify one or more content distributors with capability to distribute content to users 102a-c, and can identify programming service pricing and promotional offers available from the one or more content distributors available to the users 102a-c. Locations of users 102a-c can be obtained using broadband setup service provider service locator 208. In the exemplary cable solution, a CATV content distributor can be identified for users 102a-c by obtaining zip codes (or other indications of location) of the users 102a-c and using the broadband setup service provider service locator 208, can identify the CATV content distributors servicing the zip codes. In an exemplary embodiment, the broadband setup service provider can provide a database that maps information about users 102 to content distributors.

As shown in 302, the broadband service provider locator 208 can be used to send a query for information to an appropriate MSO consolidated sales database to determine offers available to the user 102. As shown, consolidated sales databases 210 of the CATV content distributor can be queried to determine, e.g., programming service pricing, and a promotional offers available from the CATV content distributors having the capability to distribute content to the user. Offers can include, e.g., local or national offers, local or national rebates, special offers, rebates, user-tailored offers, targeted offers, redemption certificates, coupons, discounts and content distributor-specific offers.

In 303, a CSD companion table 214 can be queried to determine such information as, e.g., offers available to the user 102.

In 304a, an offer including, e.g., the programming service price, and a promotional offer tailored to the user 102 can be routed back through broadband setup service provider locator 208 to be offered as shown in 304b to user 102 via the website of content provider 206.

In 305, the user 102 can accept the offer using, e.g., browser 106 on workstation 104 via the content provider website 206, and the acceptance of the offer can be routed to broadband setup service provider locator 208 or otherwise to update the subscription of the user 102.

In 306a, an activation request can be sent through broadband setup service provider locator 208 to the MSO CSD database 210 for automated activation.

As shown in 306b, the accepted order can be automatically passed off for activation in 307.

Upon activation, the user 102 can be provided confirmation of activation (not labeled), e.g., via an email, information on the content provider website, or other communication to the user 102.

An exemplary series of graphical user interface (GUI) screenshots of an exemplary content provider website 206 system for a user 102 to receive an offer and provide an acceptance of the offer, are depicted and described further below with reference to FIGS. 6-9.

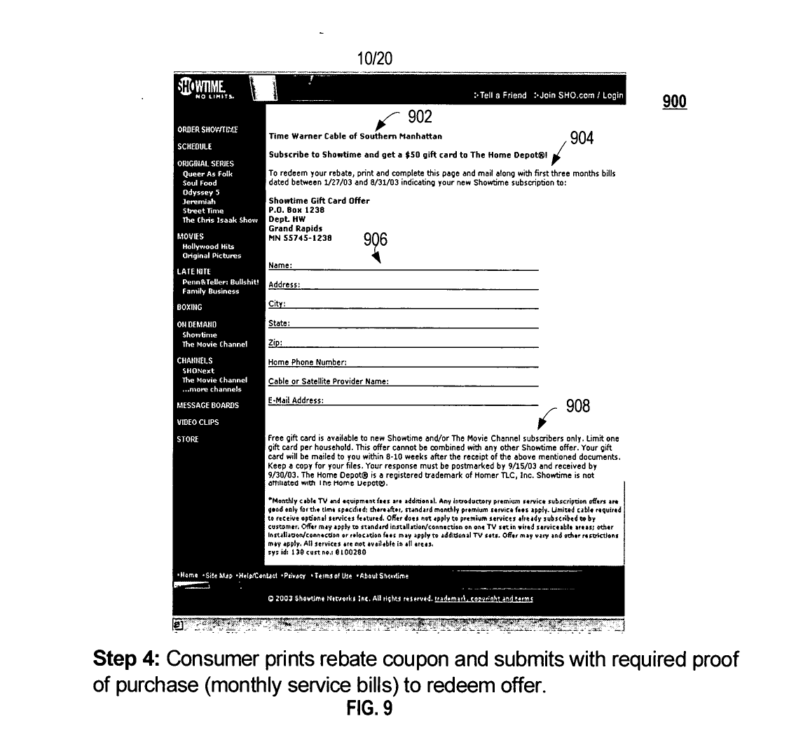

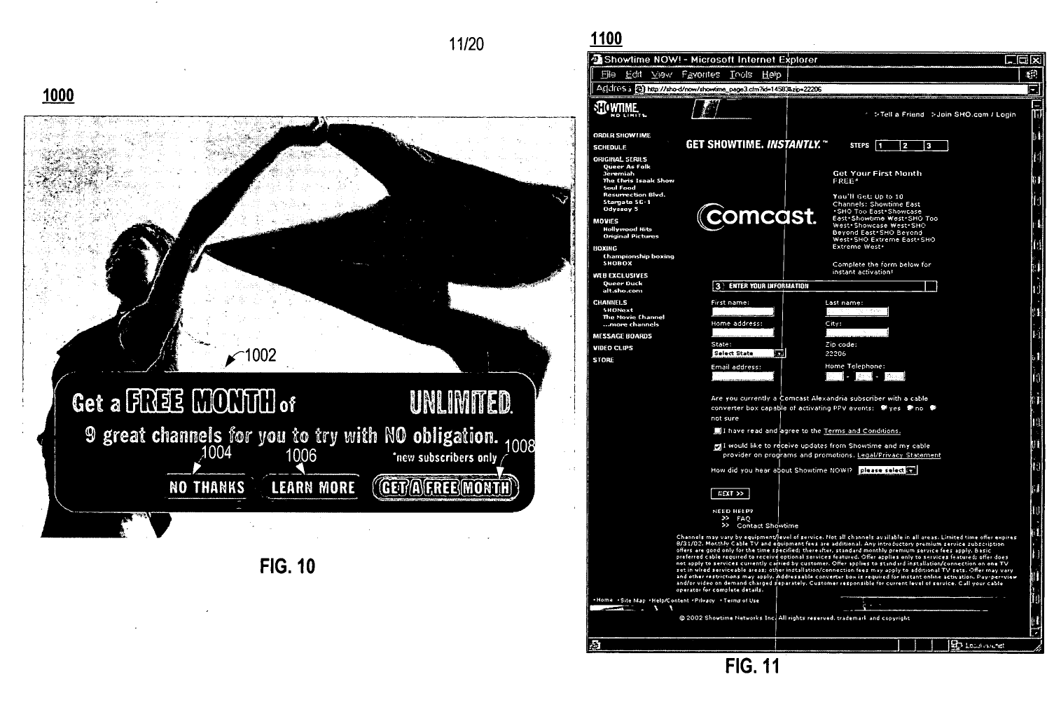

In an interactive television (ITV) alternative embodiment of offer presentation 202, a content provider ITV application 212 can present an offer including, e.g., a programming service offer and a promotional offer to users 102a-c and can receive an acceptance of the offer for the programming service via an ITV. An exemplary graphical user interface (GUI) screenshot of an ITV application is depicted in and described further below with reference to FIG. 10.

In the ITV exemplary embodiment, the ITV application 212 can access a consolidated sales database (CSD) companion table to identify information about the user and also any offer information.

As shown in diagram 300, user 102 can use an ITV application 212 to alternatively accept an offer for a programming service. The user 102 can be presented an offer on the ITV of user 102. Exemplary ITV application platforms include, e.g., WINK and OPENTV available from Liberty Broadband Interactive Television of Tulsa, Okla. USA; LIBERATE TV available from Liberate Technologies of San Carlos, Calif. USA; SEACHANGE available from SeaChange International Inc. of Maynard, Mass. USA; MICROSOFT INTERACTIVE TELEVISION (MITV) and WEBTV available from Microsoft Corporation of Redmond, Wash. USA; and CONCURRENT MEDIAHAWK available from Concurrent Computer Corporation of Duluth, Ga., USA.

As shown in 301b, in an exemplary embodiment, the ITV application 212 can query the MSO consolidated sales database 210 to determine an offer available to the user 102. The consolidated sales databases 210 can be queried by the ITV application 212 to determine, e.g., programming service pricing, and a promotional offers available from the CATV content distributor having the capability to distribute content to the user. Offers can include, e.g., programming service pricing, local or national offers, local or national rebates, special offers, rebates, user-tailored offers, targeted offers, redemption certificates, coupons, discounts and content distributor-specific offers.

In 303, a CSD companion table 214 can be queried to determine such information as, e.g., offers available to the user 102.

In 304c, an offer can be presented to user 102 via the ITV application 212.

In 305b, the user 102 can accept the offer using the ITV application 212, by, e.g., using a remote control of user 102 to select an ITV GUI element 1004-1008 as described further below with reference to FIG. 10.

From 305b, an activation request can be sent directly to the MSO CSD 210 as shown from the content provider ITV application 212.

As shown in 306b, the accepted order can be automatically passed off for activation in 307.

FIG. 3B depicts an exemplary embodiment of a more detailed diagram 320 illustrating an exemplary activation of service process for the programming service offer presentment and instant activation system 200 according to the present invention.

In diagram 320, an exemplary embodiment of activation of service 204 is shown. As noted above with reference to FIG. 2, multiple parties may be involved.

From the pass of for activation 307 from FIG. 3A, diagram 320 of FIG. 3B can, as shown in 311, communicate with provisioning server 216. The provisioning server 216 can receive the activation notice from CSD 210.

In 312a, in an exemplary embodiment, the provisioning server 216 can send a message to activate billing for the accepted programming service order to billing system 218.

In one exemplary embodiment, as shown in 312b, provisioning server 216 can also send a message to activate an access control system (skipping step 313). In an exemplary embodiment, the access control system can be a digital access controller (DAC) from MOTOROLA BROADBAND COMMUNICATIONS SECTOR of Schaumberg, Ill. USA. In another exemplary embodiment, the access control system can include a digital network control system (DNCS) available from SCIENTIFIC ATLANTA of Atlanta, Ga. USA.

In another exemplary embodiment, as shown in 313, the billing system 218 after being activated, can send a message to the access control system to activate the programming service for the user 102 using the content distributor having the capability to distribute content to the user.

Following activation of the access control system, as shown in step 314, the programming service can be active for access/viewing by the user 102. In an exemplary embodiment, the user 102 can be notified that the service has been activated.

In an exemplary embodiment, a content provider could create a provisioning server 216 for the content provider.

In another exemplary embodiment, the content provider can support development of a variety of solutions created for the content distributors.

In another exemplary embodiment, the content distributors can create a provisioning server 216.

In yet another exemplary embodiment, a satellite solution may involve direct communication with existing customer care applications of satellite content distributors.

Provisioning server 216 can be provided by such vendors as, e.g., N2 BROADBAND of Atlanta, Ga. USA, INTRANEXT of Englewood, Colo. USA, or MENTIS BROADBAND of Greenwood Village, Colo. USA. Also, a billing system application programming interface (API) based solution could be used using such products and vendors as, e.g., CARE EXPRESS available from CSG Systems of Englewood, Colo. USA, CYBER CSR available from DST SYSTEMS of Kansas City, Mo. USA, or API Gateway available from CONVERGYS of Cincinnati, Ohio USA. Other 3^{rd} party developers could be used including, e.g., systems integrators such as, e.g., BUSINESS EDGE of East Brunswick, N.J. USA, SIGMA of San Carlos, Calif. USA, CEON of Redwood City, Calif. USA, ADC of Eden Prairie, Minn. USA, and RED OAK SOFTWARE of Mountain Lakes, N.Y. USA (emulation software development kit), and provisioning/operational support system (OSS) vendors such as, e.g., LEMUR NETWORKS of Eatontown, N.J. USA, CORE NETWORKS of Silicon Valley, Calif. USA, ALOPA NETWORKS of Sunnyvale, Calif. USA, and JACOBS RIMELL of Herndon, Va. USA.

As noted with reference to FIG. 2, above, in some cases activation may fail. Activation can fail for such reasons as, e.g., communication failure, denial of service, or equipment failure. In these instances, in an exemplary embodiment, the lead can be referred to, e.g., a content distributor to attempt to activate service later, or to follow up with the potential customer. Alternatively, the lead can be forwarded to a service provider such as, e.g., an outbound telemarketing call center to resolve any impediments to activating service. An example of when service activation might be denied includes, e.g., where users 102a-c have billing or credit issues, the CSD database 210 can trigger follow-up with users 102a-c as shown in 224 of FIG. 2. In an exemplary embodiment, so-called “hot-leads” can be stored in a repository 224 and can trigger follow-on, outbound customer service responses (CSRs) such as, e.g., a telemarketing call to attempt to resolve whatever issues exist to allow providing the user the service offering.

FIG. 4 depicts an exemplary embodiment of a computer and/or communications system as can be used for several components of the programming service offer presentment system and instantaneous activation system in an exemplary embodiment of the present invention. FIG. 4 depicts an exemplary embodiment of a computer 104, 114, 116, 118, and 120 as can be used for several computing devices in the present invention. FIG. 4 is a block diagram of a computer workstation 104a, 104b, 104c system that can be used for retrieving information using browsers 106a, 106b, 106c such as, e.g., a web browser to interact with the instantaneous offer presentment and activation system 200 of the present invention. Computer 104 can include, e.g., any computer device, or communications device including, e.g., a personal computer (PC), a workstation, a mobile device, a phone, a handheld PC, a personal digital assistant (PDA), a thin client, a fat client, an network appliance, an Internet browser, a paging, or alert device, a television, an interactive television, a receiver, a tuner, a high definition television, an HD receiver, a VOD system, an SVOD system, a server, or other device. The system 200 can initiate and activate access to distributed content by interacting with application systems including billing system 218 and DAC 220, and can interact with and store data that can be stored on database 112 that can be accessible via web server 118 and application server 120. The computer system is now described in the context of a workstation 104a, 104b, 104c (collectively 104) retrieving information from database 112 on application server 120. Computer 104, in an exemplary embodiment, can comprise a central processing unit (CPU) or processor 404 coupled to a bus 402. Processor 404 can, e.g., access main memory 406 via bus 402. Computer 104 can be coupled to an input/output (I/O) subsystem such as, e.g., a network interface card (NIC) 422, or a modem 424 for access to network 108. Computer 104 can also be coupled to a secondary memory 408 directly via bus 402, or via main memory 406. Secondary memory 408 can include, e.g., a disk storage unit 410 or other storage medium. Exemplary disk storage units 410 can include, e.g, a magnetic storage device such as, e.g., a hard disk, an optical storage device such as, e.g., a write once read many (WORM) drive, or a compact disc (CD), or a magneto optical device. Another type of secondary memory 408 can include a removable disk storage device 412 which can be used in conjunction with a removable storage media 414, such as, e.g. a CD-ROM, or a floppy diskette. In general, the disk storage unit 410 can store an application program for operating the computer system referred to commonly as an operating system, such as, e.g., Windows 98/2000/XP, LINUX or other variations of UNIX, etc. The disk storage unit 410 can also store documents of a database 112. The computer 104 can interact with the I/O subsystems and disk storage unit 410 via bus 402. The bus 402 can also be coupled to a display 420 for output, and input devices such as, e.g., a keyboard 418 and a mouse or other pointing/selection device 416 that can be used to activate mouse pointer cursor 212.

The computer 104 can execute the browser 106 application program that can be used to enter responses to prompts, as well as to display information and redemption certificates for later output using information from database 112. Database 112 can include, e.g., consolidated sales database (CSD) companion table 214, broadband service provider service locator, and consolidated sales databases (of an MSO, a DBS, an affiliate, a multi-channel video program distributor (MVPD), and/or other content distributor). The data can be retrieved from the disk storage unit 410 on computer 104, or another computer system such as, e.g., application server 120, provisioning server 216, billing system 218, DAC 220, an content streaming server, a data server, a video server, or other computer or server. In an exemplary embodiment, the search results can be displayed using a television, or a graphical user interface as shown in the attached figures, or using an application program such as, e.g., one written in, e.g., a combination of Flash and Java programming language and can be implemented as a web browser 106 enabled application or applet. The application program can include a series of instructions that can cause the computer 104 via, e.g., browser 106, to retrieve documents, or parts thereof, which can be stored in one or more databases 112 coupled to a server computer system such as, e.g., application server 120. The graphical user interface (GUI) can advantageously display the response to queries on display 420 for manipulation by using mouse 416 or a remote control device to interact with GUI. The GUI can be manipulated via other common devices such as, e.g., a keyboard 418, such as, e.g., the cursor arrow keys on a keyboard. Although the invention is described in reference to a computer, or a computer workstation, another computing or communication device is equally suitable to using the present invention, such as, e.g., a wireless device, a communications device, a television and/or receiver, a personal digital assistant (PDA), a thin client, fat client, x-station, browser, or other network appliance.

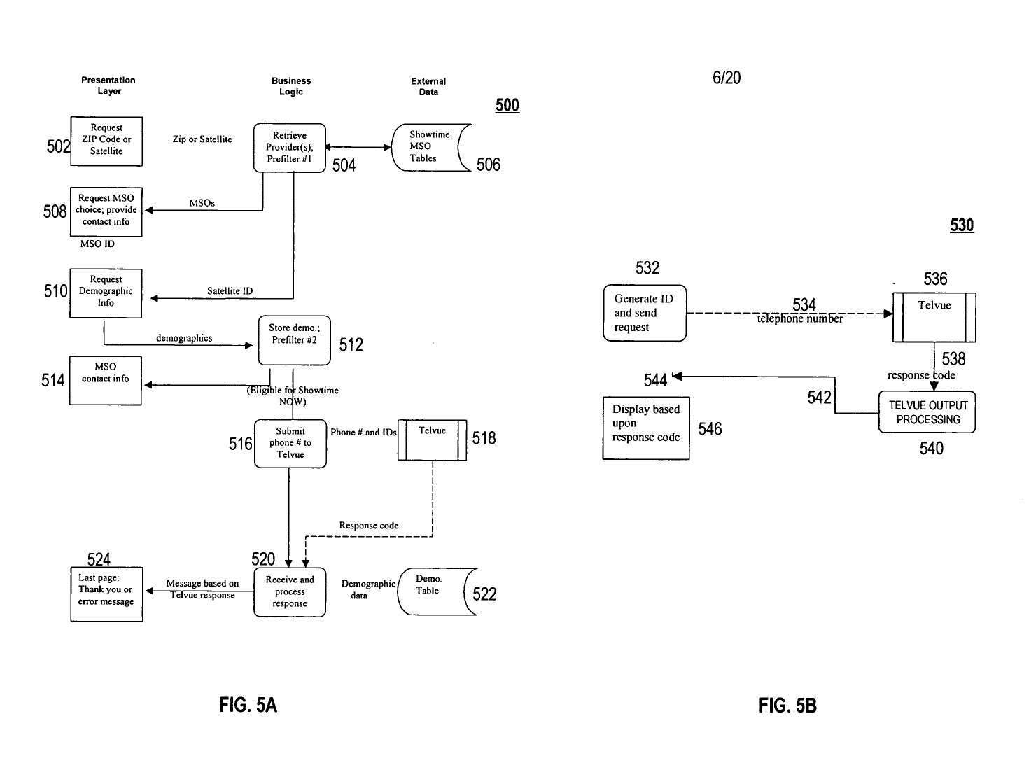

FIG. 5A depicts an exemplary embodiment of a flow chart 500 illustrating an exemplary process of establishing a limited duration pay per view event using Telvue.

In 502, in an exemplary embodiment, a zip code or indication that a satellite content distributor is used can be received from the presentation layer.

In 504, in an exemplary embodiment, business logic can retrieve one or more providers for the user 102 and can perform a first prefilter.

In 506, in an exemplary embodiment, the business logic can access content provider MSO tables from external data.

In 508, for MSOs content distributors, the presentation layer can request the MSO choice from the user, and request that the user 102 provide contact information.

In 510, for satellite content distributors, the presentation layer can request demographic information from the user 102.

In 512, the business logic can store the demographic information and can perform an additional prefilter.

In 514, from 512, if the user 102 is eligible for the programming service, the MSO contact information can be provided to the user 102 by the business logic to the presentation layer.

In 516, from 512, if the user 102 is eligible for the programming service, the phone number can be provided to a pay per view service provider such as, e.g., TELVUE of Mt. Laurel, N.J., U.S.A.

In 518, Telvue is shown receiving the phone number and identification information and can provide a response code as shown to the business logic at 520.

In 520, the business logic can receive and process a response. As shown in 522, external demographic table data can be accessed.

In 524, a last page, thank you or error message can be show at the presentation layer, when a message based on the Telvue response is received from the business logic.

FIG. 5B depicts another exemplary embodiment of a flow chart 530 illustrating an exemplary process 530 of establishing an experimental limited duration pay per view event.

Flow chart 530 can include in 532, generating an id and sending a request, such as telephone number 534 to Telvue 536. Telvue 536 as shown at 538 can send a response code to Telvue output processing 540. As shown at 542, the output processing can send 544 or store the information. Then as shown at 546, the program can be displayed based upon the response code.

FIG. 6 depicts an exemplary embodiment of a GUI 600 depicting an exemplary first step of a programming service offer presentment system and instantaneous activation system prompting for user identification according to the present invention.

Offer 602, in an exemplary embodiment, offers a programming service along with a promotional offer, in this case a gift certificate for use at a retail establishment.

In the exemplary embodiment, the user 102 can enter a zip code in field 604 to identify the location of the user 102.

Alternatively, the user 102 can select a satellite content distributor using links 606.

In another exemplary embodiment, a telephone number 608 can be provided to allow a user 102 to telephone a customer service center to handle activation of the programming service.

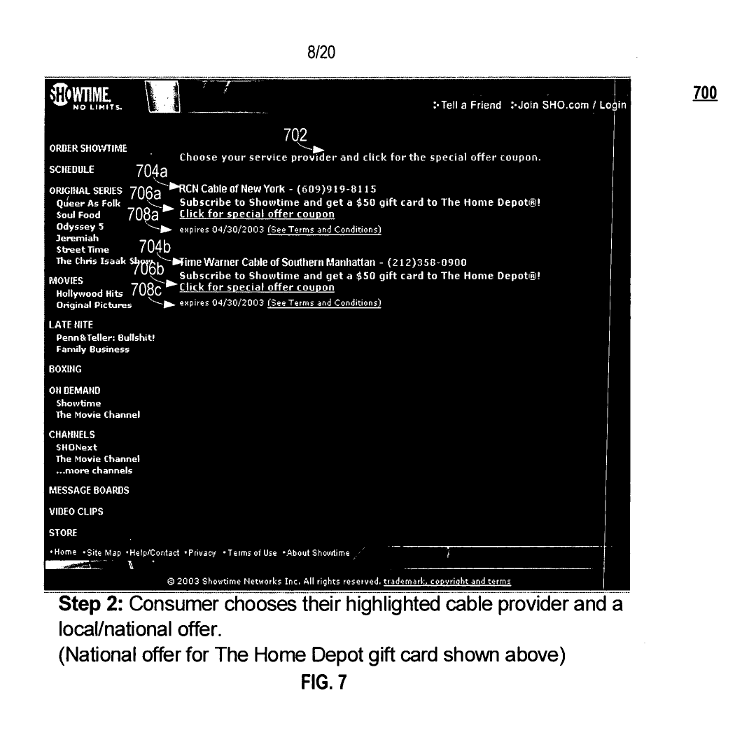

FIG. 7 depicts an exemplary embodiment of a GUI 700 depicting an exemplary second step of the programming service offer presentment system and instantaneous activation system providing a list of content distributors capable of providing the programming service to the user 102, i.e., servicing the zip code entered in field 604, following selection of the <<next>> button of GUI 600. The list of content distributors, in an exemplary embodiment, can be identified by using the user identification information inputted previously, and by querying a database such as, e.g., that shown in the GUI of FIG. 12. As illustrated, GUI 700 can include content distributors 704a, 704b, and can include content distributor-specific offers 706a, 706b, respectively. Additionally, in an exemplary embodiment, an expiration date 708a, 708b for the promotional offer can be provided, as well as a link to terms and conditions.

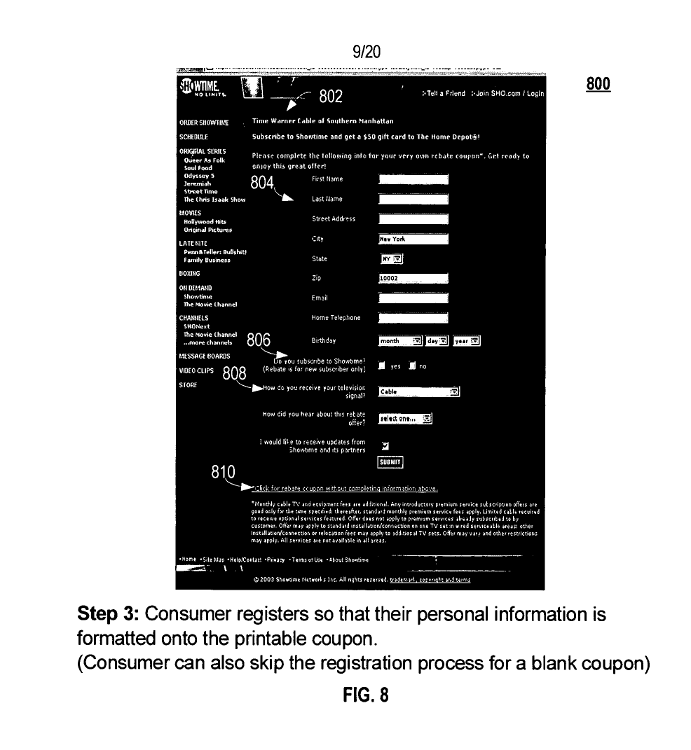

FIG. 8 depicts an exemplary embodiment of a GUI 800 depicting an exemplary third step of programming service offer presentment system and instantaneous activation system prompting the user 102 to provide additional exemplary registration and/or demographic information and to request an exemplary promotional offer, coupon or redemption certificate according to the present invention. GUI 800 includes, in an exemplary embodiment, an indication of the content distributor capable of distributing the programming service to the user 102. Fields 804 can accept input from the user 102 including, e.g., demographic information. Offer acceptance field 806 allows the user 102 to accept the offer presented. Various other information 808 can be provided including, e.g., a field to allow the user 102 to indicate how the user 102 receives television programming, a field indicating how the user 102 learned of the offer, an opt in/opt out field to obtain further information, and a submission button for submitting the offer acceptance. The information entered by the user 102 can be used to fill in a coupon that can then later be printed. Link 810 can provide a link to a coupon such as, e.g., the redemption certificate 900 shown in FIG. 9.

FIG. 9 depicts an exemplary embodiment of a GUI 900 depicting an exemplary fourth step of programming service offer presentment system and instantaneous activation system providing a user-printable rebate coupon, or redemption certificate for redeeming an offer according to an exemplary embodiment of the present invention. If the user 102 has not entered any demographic information into GUI 800, and selects link 810, skipping the registration process, then GUI 900 can be displayed providing a blank coupon including content distributor 902, offer 904, user information blanks 906 to be filled in after printing by user 102, and offer 908 providing additional details of the offer 904. In an exemplary embodiment, the rebate coupon can be submitted by mail to the content provider along with a proof of purchase such as, e.g., a monthly service bill from the content distributor indicating payment for the programming service.

FIG. 10 depicts an exemplary embodiment of a graphical user interface depicting an exemplary interactive television (iTV) interface offering an programming service offer presentment system and instantaneous activation system according to the present invention. FIG. 10 illustrates GUI 1000 depicting an exemplary embodiment of an ITV GUI screen having a GUI element 1002 that presents an offer to user 102. The offer includes selection buttons 1004 to decline the offer, 1006 to inquire further, and 1008 to accept the offer (in this case along with a promotional offer for a free month of service).

FIG. 11 depicts an exemplary embodiment of a GUI 1100 of an experimental limited use online web based pay-per-view sign up system for providing a programming service offer presentment and instantaneous activation for a fixed duration program according to an exemplary embodiment.

FIG. 12 depicts an exemplary embodiment of a GUI 1200 depicting an exemplary CATV cable service locator database query interface that could be used as a component of the present invention.

FIG. 13 depicts an exemplary embodiment of a GUI 1300 depicting an exemplary iTV electronic commerce interface that could be interactively used by a user 102 to order a programming service using an iTV system as shown. The ITV commerce application can present an offer for the programming service as shown.

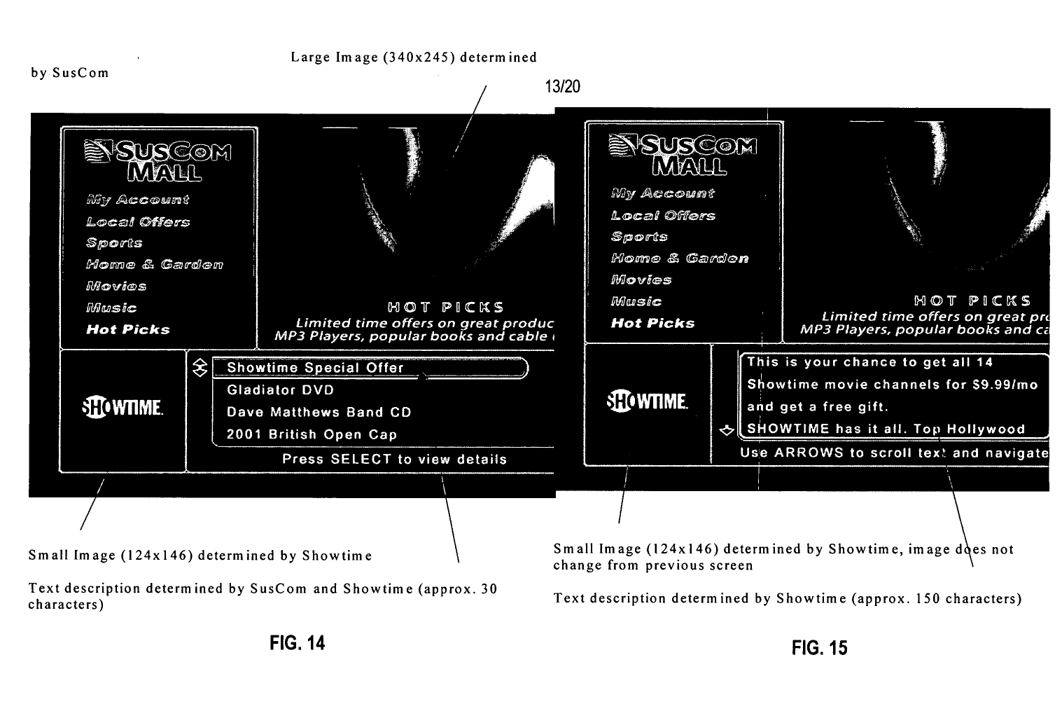

FIG. 14 depicts an exemplary embodiment of a GUI 1400 depicting an exemplary iTV electronic commerce interface that could be interactively used by the user 102 to order a programming service. Similarly to GUI 1300, GUI 1400 can provide via an ITV commerce application, presentment of an offer for the programming service as shown.

FIG. 15 depicts an exemplary embodiment of a GUI 1500 depicting another exemplary iTV electronic commerce interface providing scrollable details that could be interactively used by a user to order a programming service.

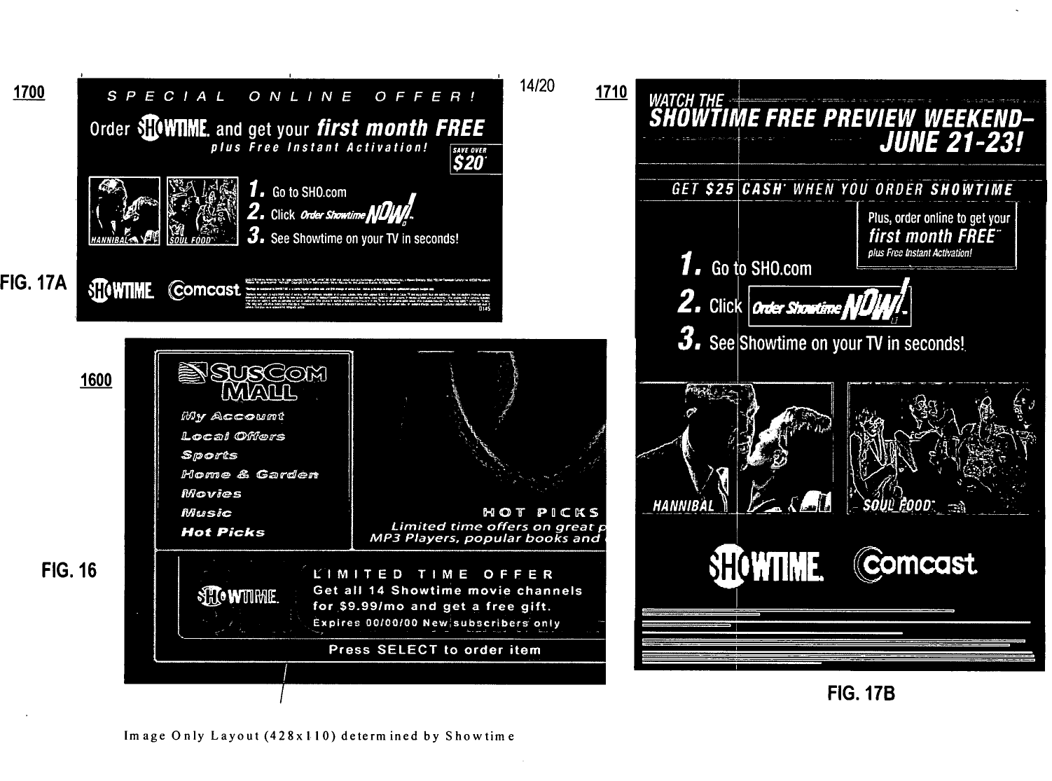

FIG. 16 depicts an exemplary embodiment of a GUI 1600 depicting an exemplary iTV electronic commerce interface promotional advertisement offering a subscription and a gift that could be interactively used by a user to order a programming service.

FIGS. 17A and 17B depict exemplary embodiments of promotional materials 1700 and 1710, respectively, that could be used to market an exemplary programming service offer presentment system and instantaneous activation system according to exemplary embodiments of the present invention.

Conventionally, there are various web-based postcard applications dating back to 1995 and 1996. In an exemplary embodiment of the present invention, a sending user 102 using an ITV client may prepare and send an electronic postcard to an email address of a recipient user 102, including a link to an instantaneous programming service offer presentment and activation website.

Electronic Postcard (“Tell a Friend”) With Instantaneous Offer Presentment and Activation

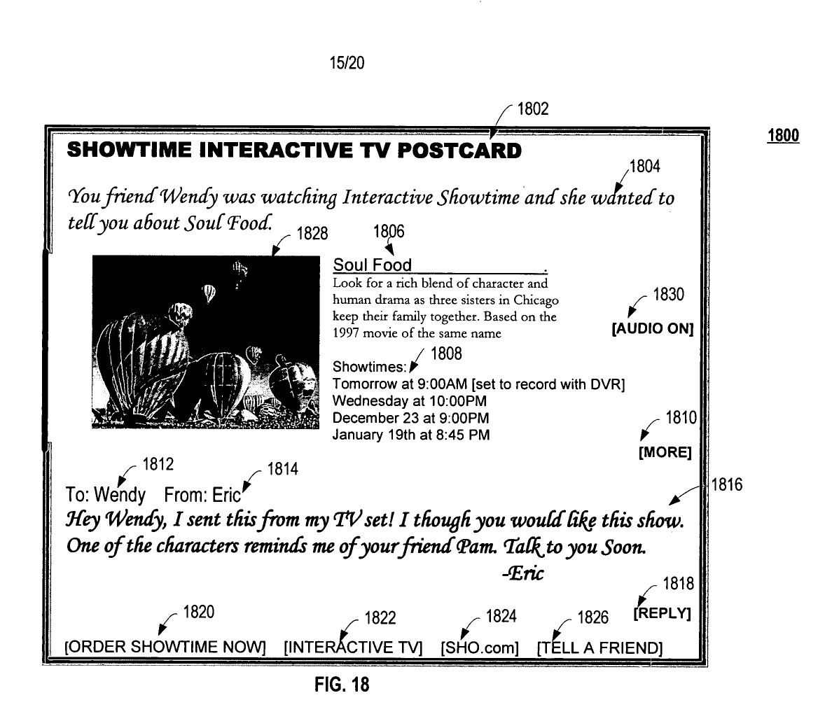

In an exemplary embodiment of the present invention, a sending user 102a may prepare and send from an interactive television (ITV) client, or workstation 104a, an electronic postcard 1800 (discussed further below with reference to FIG. 18), sometimes referred to herein as a “tell a friend” postcard. An exemplary embodiment of an electronic postcard 1800 can include, e.g., a display of graphics, video and sound along with a textual message from the sending user 102a to a receiving user 102b. The postcard 1800 may result from a sending user 102a interacting with a software application on the user's ITV client, browser 106a, or workstation 104a to communicate with a receiving user 102b including an instantaneous offer presentment and activation system, optional advertising, and/or other content such as, e.g., notice of upcoming episode showtimes, a digital video recorder (DVR) reminder, and/or a calendar reminder. Postcards 1800 provide a way for viewing users 102 to communicate with others while helping promote a content provider's programming service. Postcards 1800 provide links to an instantaneous offer presentment and programming service order activation system according to the present invention. An exemplary instantaneous offer presentment and programming service order activation system that could be integrated with the postcard system 1800 may be, e.g., SHO.com or Order Showtime Now available from SHOWTIME NETWORKS INC.

Electronic postcards 1800, in an exemplary embodiment may share features analogous to interactive children's picture books. Consider children's books including pull tabs, bells, spinning spheres, and opening a secret door. Thus, the postcard may include interactive sections including, e.g., animation, games, and other entertaining contents.

Postcards 1800 can include, e.g., logos, promotions, special offers, and/or advertising for organizations, or parties including, e.g., a programming service, a provider, a TV program, series, or movie. Postcards 1800 can be provided for original TV programming series of a programming service, and for groups of types of programming, such as, e.g., genres including, e.g., a particular sport such as, e.g., championship boxing (with links to boxing content); original series programs such as, e.g., Chris Isaak, Queer As Folk, Dead Like Me, and Soul Food, all available from SHOWTIME (with links, e.g., to series sites); and other programming.

Postcards may include links to an instantaneous offer presentment and order activation system such as, e.g., SHO.com.

Reminder postcards 1800 can be sent providing, e.g., “Remind Me Buttons” that may be added to provide a reminder email prior to a subsequent airdate. In an exemplary embodiment, an ITV recipient having a digital video recorder (DVR) (such as, e.g., a personal video recorder (PVR)) can be provided a reminder to record a future showtime. Remind Me postcards can in an exemplary embodiment be a slimmed down version of “Tell-A-Friend” postcards, in an exemplary embodiment, without a sales pitch and full program information. A “SHO ITV” link or a “Learn more about SHO ITV” link can provide further information about a programming service, or program. A reminder can also tie into an Operator's on-screen (on the TV) pop-up reminder feature, such as, e.g., those offered in some TIME WARNER and DISH NETWORK systems. Additionally, in systems having a DVR, the Remind Me function can be replaced with a RECORD button, or the like, allowing a user to schedule a recording of a program using a DVR (assuming the user for which the program is being recorded is a subscriber).

In an exemplary embodiment, a “Reply” 1818 may allow a user to make a choice of a postcard 1800 to send, possibly with some fields pre-populated.

In an exemplary embodiment, the postcards 1800 can include rich graphics 1828. Graphics can build off of a programming service's branding and design elements that have been created for other applications. The postcard can include Flash animation with interactivity.

In an exemplary embodiment, the postcards can include sound or audio 1830 enhancements. In one exemplary embodiment, the postcard 1800 is adapted to function even if the end user does not have a sound card in the viewing computer. The postcard 1800 may be created with audio enhancements in such a way that the resulting postcard will still make sense even absent audio in the final presentation.

FIG. 18 depicts an exemplary embodiment of a graphical user interface (GUI) postcard layout 1800, illustrated so as to convey the content of an exemplary postcard. GUI 1800 may include in an exemplary embodiment, a title 1802, an introduction 1804, a program name and description 1806, showtimes 1808 (listed with intelligence, and optionally DVR/PVR enabled), more button 1810, receiving user name 1812 (or electronic mail (e-mail) address), sending user name (or e-mail address) 1814, message 1816, reply button 1818, order showtime now button 1820 (providing instantaneous offer presentment and order activation), interactive television button 1822 (capable of providing enhanced virtual channel content or information about Showtime's Interactive TV), SHO.com website link 1824, tell a friend button 1826, graphical content 1828 (that can be animated), and audio on button 1830 for enabling audio enhancements/sound.

More button 1810, allows interactive additional information to be accessed, by link or otherwise. The more button 1810 (or icon) can provide the user 102 with additional info about the program. For example, in an exemplary embodiment, a “drawer” can slide out with additional content. The additional content can include, e.g., extra content normally presented on a television program's product page of a programming service website including, e.g., rating, advisory, cast list, directors, producers, other movies of actors, directors, and the like.

The SHO.com link 1824 can provide a link to a website for a programming service such as the SHO.com website.

The INTERACTIVE TV link 1822 can provide additional information about interactive content, and how to access it, or access to a virtual channel for interactive access to additional information about a program or programming service.

The TELL A FRIEND link 1826 can either create a blank email, or can prepare a postcard to a recipient to provide a link or other method of noting how to create an electronic postcard.

The Program Name and Description 1806 can be pulled from database of information about programs and programming services.

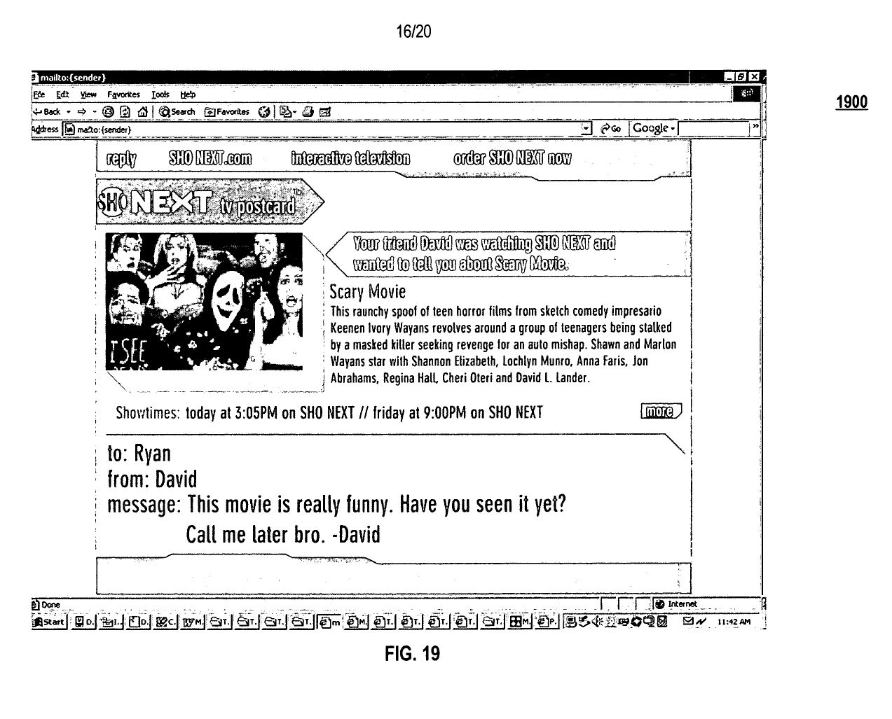

FIG. 19 includes an exemplary embodiment of an electronic postcard 1900 including a description of a specific movie and an ordering button for a programming service instantaneous activation programming service offer presentment system according to the present invention.

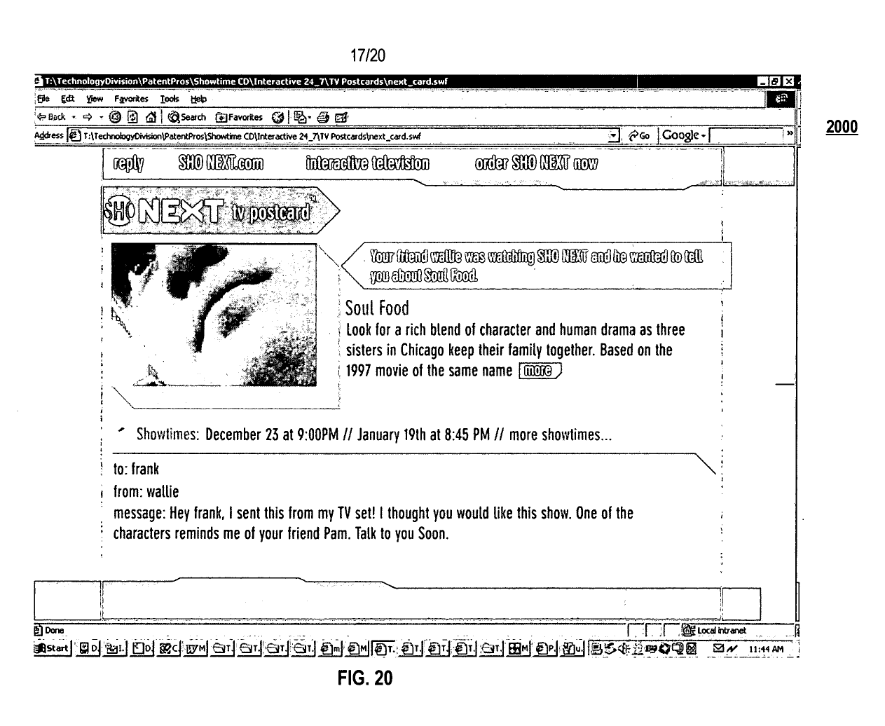

FIG. 20 includes an exemplary embodiment of an electronic postcard 2000 including a description of a programming series including an ordering button for a programming service instantaneous activation programming service offer presentment system labeled order SHO NEXT now according to the present invention.

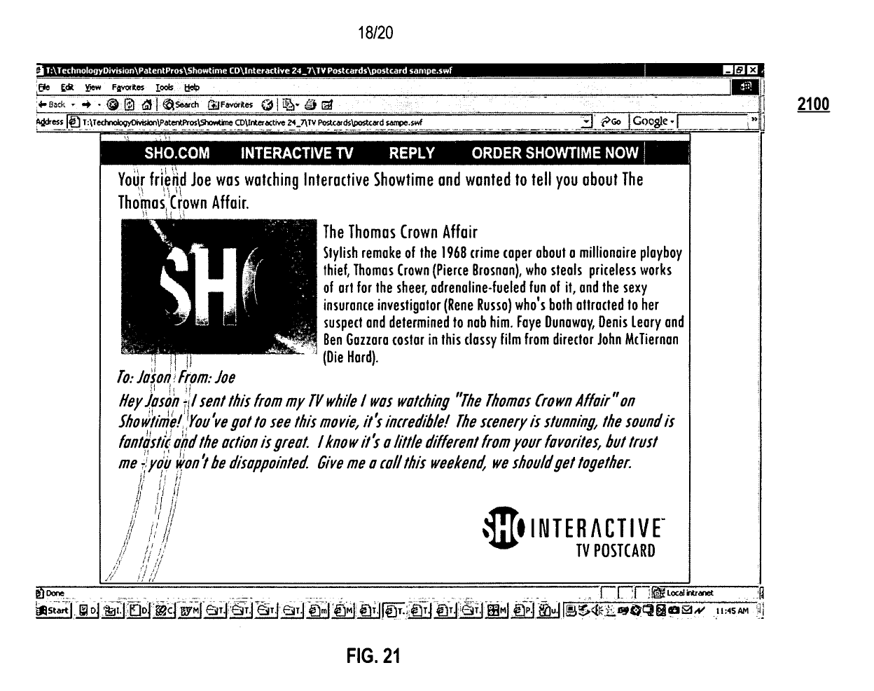

FIG. 21 includes an exemplary embodiment of an electronic postcard 2100 including a description of a movie and an ordering button for a programming service instantaneous activation programming service offer presentment system according to the present invention, labeled Order Showtime Now.

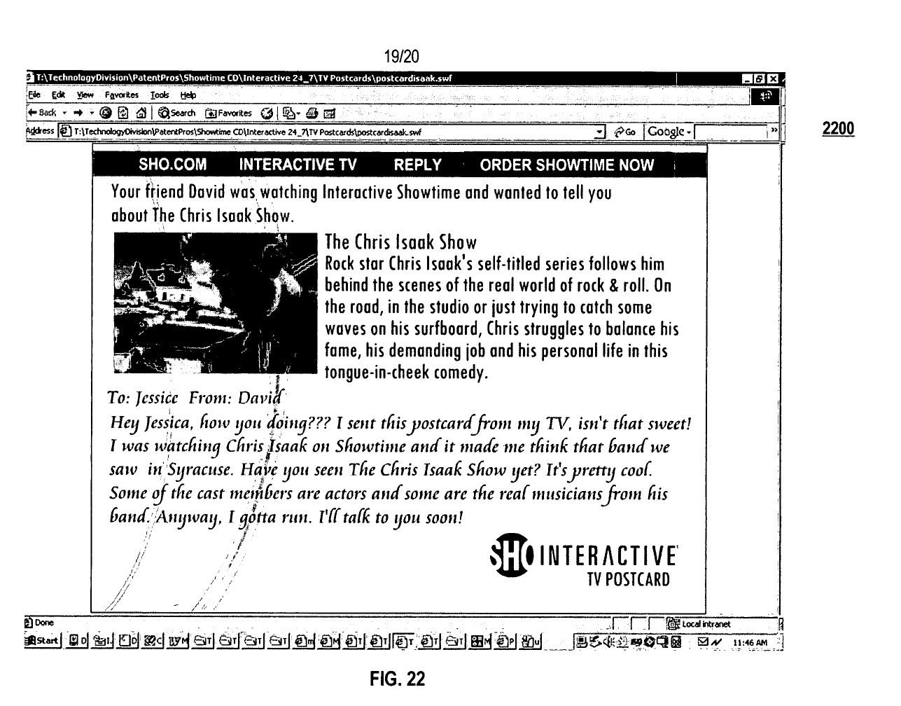

FIG. 22 includes an exemplary embodiment of an electronic postcard 2200 including a description of an original series and an ordering button for a programming service instantaneous activation programming service offer presentment system according to the present invention.

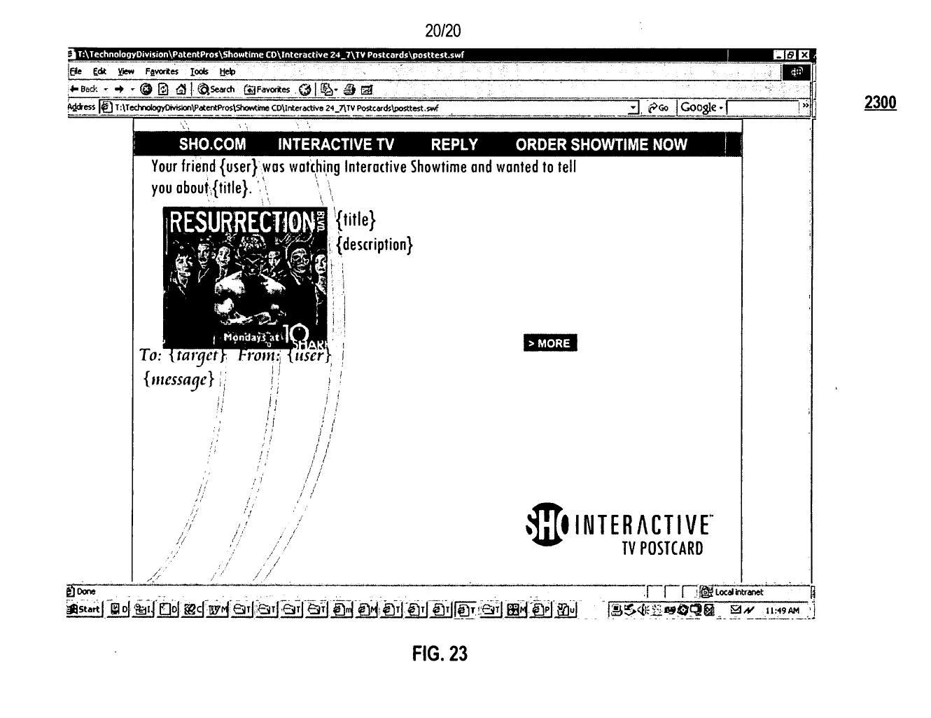

FIG. 23 includes an exemplary embodiment of an electronic postcard 2300 including a template of the postcard for an original series and an ordering button for a programming service instantaneous activation programming service offer presentment system according to the present invention.

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents. While this invention has been particularly described and illustrated with reference to a preferred embodiment, it will be understood to those having ordinary skill in the art that changes in the above description or illustrations may be made with respect to formal detail without departing from the spirit and scope of the invention.

1. A method for electronically ordering and activating a user content subscription comprising the steps of:
(a) identifying at least one content distributor available to a user;
(b) identifying a price to the user for a programming service from the at least one content distributor;
(c) presenting an offer for said programming service to the user for said price;
(d) receiving an acceptance of said offer for said programming service for said price; and
(e) activating said programming service.

2. The method according to claim 1, wherein said (e) comprises:
(1) determining whether activation fails; and
(2) forwarding said acceptance of said offer for said programming service to the at least one content distributor, if said activation fails.

3. The method according to claim 2, wherein said activation fails when at least one of:
communication fails with the at least one content distributor;
communication with a device of the user fails; and
activation is denied.

4. The method according to claim 1, wherein said offer comprises:
a programming service price; and
a promotional offer.

5. The method according to claim 4, wherein said programming service price comprises at least one of:
a user-tailored programming service price;
a tiered user service level price;
a user demographically-tailored programming service price; and
a user psychographically-tailored programming service price.

6. The method according to claim 4, wherein said programming service price comprises at least one of:
a general price;
a content distributor-specific price; and
a discounted price.

7. The method according to claim 4, wherein said promotional offer comprises at least one of:
a user-tailored offer;
a rebate;
a discount;
a free install;
a free term of service;
a gift certificate;
a redemption certificate;
a coupon;
a content distributor-specific offer;
a user demographically-tailored offer;
a user psychographically-tailored offer; and
a special offer associated with the at least one content distributor.

8. The method according to claim 1, wherein said step (a) comprises:
(1) receiving an indication of a location of the user; and
(2) querying a database that maps the at least one content distributor to said indication of said location of the user.

9. The method according to claim 1, wherein the at least one content distributor comprises at least one of:
a cable television (CATV) content distributor;
a satellite content distributor;
a wired content distributor;
a wireless content distributor;
an Internet content distributor; and
a multi-channel video program distributor (MVPD).

10. The method according to claim 1, wherein the at least one content distributor comprises:
a content distributor presently delivering content to the user.

11. The method according to claim 8, wherein said indication of said location of the user comprises at least one of: a zip code; a phone number; an address; an internet protocol (IP) address; a geographical indication; a global positioning system (GPS) identified location; and a reverse 411 identified location.

12. The method according to claim 1, wherein said offer comprises at least one of:
a programming service price;
a promotional offer;
a rebate;
a free install;
a free term of service;
a gift certificate;
a local rebate;
a national rebate;
a local offer;
a national offer;
a targeted offer;
an offer targeted to the user using at least one of demographic and psychographic information about the user;
a discount;
a content distributor-specific offer;
a user-tailored programming service price;
a tiered user service level price;
a user demographically-tailored offer;
a user demographically-tailored programming service price;
a user psychographically-tailored offer;
a user psychographically-tailored programming service price;
an offer associated with the at least one content distributor presently delivering content to the user;
a programming service price associated with the at least one content distributor presently delivering content to the user;
a redemption certificate; and
a coupon.

13. The method according to claim 1, wherein said step (e) comprises at least one of:
(1) activating a billing system; and
(2) activating an access control system to distribute said programming service to the user.

14. The method according to claim 13, wherein said step (2) comprises at least one of:
Placing a programming service in a channel guide of the user;
activating said programming service;
providing access to said programming service; and
enabling premises equipment to decode said programming service.

15. The method according to claim 1, wherein said step (d) comprises at least one of:
(1) receiving said acceptance via at least one of:
a set-top box,
a television (TV),
a browser,
a digital video recorder (DVR),
a computer,
a personal digital assistant (PDA),
a wireless device,
a communications device,
a phone, and
an Internet browser.

16. The method according to claim 1, wherein said step (a) comprises:
(1) identifying at least one content distributor having capability to deliver content to a user.

17. The method according to claim 1, wherein said step (a) comprises:
(1) identifying at least one content distributor presently delivering content to a user.

18. The method according to claim 1, further comprising, prior to said (a):
(f) transmitting an electronic postcard from a sending user to a receiving user wherein said postcard comprises information about programming service content, and wherein said postcard comprises a link to the method for electronically ordering and activating the user content subscription.

19. A system for electronically ordering and activating a user content subscription comprising:
content distributor identification means for identifying at least one content distributor available to a user;
pricing means for identifying a price to the user for a programming service from the at least one content distributor;
presentment means for presenting an offer for said programming service to the user for said price;
acceptance means for receiving an acceptance of said offer for said programming service for said price; and
activation means for activating said programming service.

20. The system according to claim 19, wherein said activation means comprises:
means for determining whether activation fails; and
means for forwarding said acceptance of said offer for said programming service to the at least one content distributor, if said activation fails.

21. The system according to claim 20, wherein said activation fails when at least one of:
communication fails with the at least one content distributor;
communication with a device of the user fails; and
activation is denied.

22. The system according to claim 19, wherein said offer comprises:
a programming service price; and
a promotional offer.

23. The system according to claim 22, wherein said programming service price comprises at least one of:
a user-tailored programming service price;
a tiered user service level price;
a user demographically-tailored programming service price; and
a user psychographically-tailored programming service price.

24. The system according to claim 22, wherein said programming service price comprises at least one of:
a general price;
a content distributor-specific price;
a discounted price.

25. The system according to claim 22, wherein said promotional offer comprises:
a user-tailored offer;
a rebate;
a discount;
a free install;
a free term of service;
a gift certificate;
a redemption certificate;
a coupon;
a content distributor-specific offer;
a user demographically-tailored offer;
a user psychographically-tailored offer; and
a special offer associated with the at least one content distributor.

26. The system according to claim 19, wherein said content identification means comprises:
means for receiving an indication of a location of the user; and
means for querying a database that maps the at least one content distributor to said indication of said location of the user.

27. The system according to claim 19, wherein the at least one content distributor comprises at least one of:
a cable television (CATV) content distributor;
a satellite content distributor;
a wired content distributor;
a wireless content distributor;
an Internet content distributor; and
a multi-channel video program distributor (MVPD).

28. The system according to claim 26, wherein said indication of said location of the user comprises at least one of: a zip code; a phone number; an address; an internet protocol (IP) address; a geographical indication; a global positioning system identified location; and a reverse 411 identified location.

29. The system according to claim 19, wherein said offer comprises at least one of:
a programming service price;
a promotional offer;
a rebate;
a national rebate;
a local rebate;
a free install;
a free term of service;
a gift certificate;
a local rebate;
a national rebate;
a promotional offer;
a local offer;
a national offer;
a targeted offer;
an offer targeted to the user using at least one of demographic and psychographic information about the user;
a discount;
a content distributor-specific offer;
a user-tailored programming service price;
a tiered user service level price;
a user demographically-tailored offer;
a user demographically-tailored programming service price;
a user psychographically-tailored offer;
a user psychographically-tailored programming service price;
an offer associated with the at least one content distributor presently delivering content to the user;
a programming service price associated with the at least one content distributor presently delivering content to the user;
a redemption certificate; and
a coupon.

30. The system according to claim 19, wherein said activation means comprises at least one of:
billing means for activating a billing system; and
access means for activating an access control system to distribute said programming service to the user.

31. The system according to claim 30, wherein said access means comprises at least one of:
means for placing in a channel guide of the user;
means for activating said content;
means for providing access to said content; and
means for enabling premises equipment to decode said content.

32. The system according to claim 19, wherein said acceptance means comprises at least one of:
means for receiving said acceptance via at least one of:
a set-top box,
a television (TV),
a browser,
a digital video recorder (PVR),
a computer,
a personal digital assistant (PDA),
a wireless device,
a communications device,
a phone, and
an Internet browser.

33. The system according to claim 19, wherein said content distributor identification means comprises:
means for identifying at least one content distributor having capability to deliver content to a user.

34. The system according to claim 19, wherein content distributor identification means comprises:
means for identifying at least one content distributor presently delivering content to a user.

35. The system according to claim 19, further comprising:
means for transmitting an electronic postcard from a sending user to a receiving user wherein said postcard comprises information about programming service content, and wherein said postcard comprises a link to the system for electronically ordering and activating the user content subscription.

36. A computer program product embodied on a computer readable medium comprising program logic for instantaneously activating enhanced content comprising:
content distributor identification means for enabling a computer to identify at least one content distributor available to a user;
pricing means for enabling the computer to identify a price to the user for a programming service from the at least one content distributor;
presentment means for enabling the computer to present an offer for said programming service to the user for said price;
acceptance means for enabling the computer to receive an acceptance of said offer for said programming service for said price; and
activation means for enabling the computer to activate said programming service.
